(19) United States
(12) Patent Application Publication
(10) Pub. No.: US 2024/0423192 A1
(43) Pub. Date: Dec. 26, 2024

(54) Insect Repellant Device Having Replaceable Repellant

(71) Applicant: Woodstream Corporation, Lancaster, PA (US)

(72) Inventors: Marko Lubic, Shillington, PA (US); Michael Muilwyk, Felton, PA (US); Adam V. Malave, Elizabethtown, PA (US)

(73) Assignee: Woodstream Corporation, Lancaster, PA (US)

(21) Appl. No.: 18/341,314

(22) Filed: Jun. 26, 2023

(51) Int. Cl. A01M 29/12

(52) U.S. Cl. CPC A01M 29/12

(57) ABSTRACT

An insect repellent device includes a selectively closable vent providing fluid communication between an interior of the device and the external environment, a repellent holder, and a sensor. The repellent holder is movable between an operating position wherein repellent contained by the holder is arranged within the device, and a loading position wherein the repellent holder is arranged at least partially outside of the device. The sensor is adapted to detect the presence of the repellent holder at least in the operating position. A timer is provided for determining a duration the repellant holder is maintained in the operating position.

### FIELD OF THE INVENTION

The present invention relates to the field of pest control, and more particularly, to an insect repellent dispensing device and associated control system.

### BACKGROUND

Mosquitos, black flies and other biting insects are a common nuisance. Insect repellents and insecticides are among the most common agents employed against such attacks. Particularly in pedestrian settings, devices exist which emit insect repellent at the will of a user, such as during a social gathering. These devices may include replaceable repellent cartridges or repellent-soaked pads, and utilize fans to move air through the device, exposing it to the repellent contained therein. The air is then expelled into the surrounding environment. Current devices are not without drawbacks, however. For example, replacement of a repellent cartridge or pad is often unnecessarily difficult and/or uncleanly. Existing devices often expose the repellent to near-constant airflow, even when they are not in use and/or their internal fans deactivated. This leads to premature repellent depletion or potency reduction. Further, these devices lack effective means to determine, and/or alert a user to, the state of the repellent contained therein, which may include factors such as repellent age and remaining repellent quantity.

### SUMMARY

An insect repellent device according to an embodiment of the present disclosure includes a selectively closable vent providing fluid communication between an interior of the device and the external environment, a repellent holder, and a sensor. The repellent holder is movable between an operating position wherein repellent contained by the holder is arranged within the device, and a loading position wherein the repellent holder is arranged at least partially outside of the device. The sensor is adapted to detect the presence of the repellent holder at least in the operating position.

According to another embodiment, an insect repellent device comprises a housing including an at least partially removable repellent holder, a controller, and a sensor operatively connected to the controller and adapted to detect the presence or position of the repellent holder within the housing.

A method of operating an insect repellent device according to an embodiment of the present disclosure includes the steps of: 1) with a repellent holder installed in the device and the device in an activated state, activate a first timer; 2) with the repellent holder installed in the device and the device in a deactivated state, activating a second timer; 3) if the first timer reaches a first predetermined threshold time, providing an alert to a user; and 4) if the second timer reaches a second predetermined threshold time, providing an alert to the user.

### BRIEF DESCRIPTION OF THE DRAWINGS

The invention will now be described by way of example with reference to the accompanying figures, of which:

FIG. 1 is front perspective view of an insect repellent device according to an embodiment of the present disclosure;

FIG. 2 is partial rear perspective view of a repellent holder assembly of the device of FIG. 1 with a repellent holder thereof in a first or installed position;

FIG. 3 is partial side perspective view of the repellent holder assembly of FIG. 2;

FIG. 4 is partial side view of a rear of the repellent holder assembly of the preceding figures;

FIG. 5 partial side perspective view of the device of FIG. 1 with a portion of a cover thereof removed and the repellent holder in the first position;

FIG. 6 is a partial cross-sectional view of the device of FIG. 1 with the repellent holder in a second or loading position;

FIG. 7 is partial bottom view of the device of FIG. 1 in a storage or deactivated state;

FIG. 8 is partial bottom view of the device of FIG. 8 in an operating or activated state;

FIG. 9 is partial bottom view of the device of the preceding figures with a bottom cover and repellent holder assembly thereof removed in the activated state;

FIG. 10 is partial bottom view of the device of FIG. 9 in the deactivated state; and

FIG. 11 is a simplified diagram illustrating a processor and an associated operating process of a device according to embodiments of the present disclosure.

### DETAILED DESCRIPTION OF THE EMBODIMENTS

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

Embodiments of the present disclosure improve prior art insect repellent delivery systems by improving repellent replacement processes, limiting unnecessary repellent exposure to the environment, and generating useful user alerts as to repellent state. According to an embodiment, a repellent delivery device includes a repellent holder adapted to be loaded with a repellent-infused pad (by way of example only). The holder is movably mounted within the device housing between an installed or operating position and an ejected or loading position. The holder is designed to be loaded and unloaded with minimal to no contact with the existing repellent. The device further features closable shutters or vents both above and below the repellent pad. In this way, airflow across the repellent pad is minimized when the device is not in use.

Finally, intelligent programming of the device enables the generation of timed status indicators, providing a user with information regarding the state of the repellent in the device, including visual alerts indicating the need for repellent replacement. Specifically, the device is adapted to independently monitor the time the repellent holder has been continuously maintained in the operating position both when the device is turned on and/or active, as well as when it is turned off and/or inactive. Comparison of either of these monitored times to predetermined thresholds may be used to trigger audio or visual indications to a user regarding the need to replace the repellent.

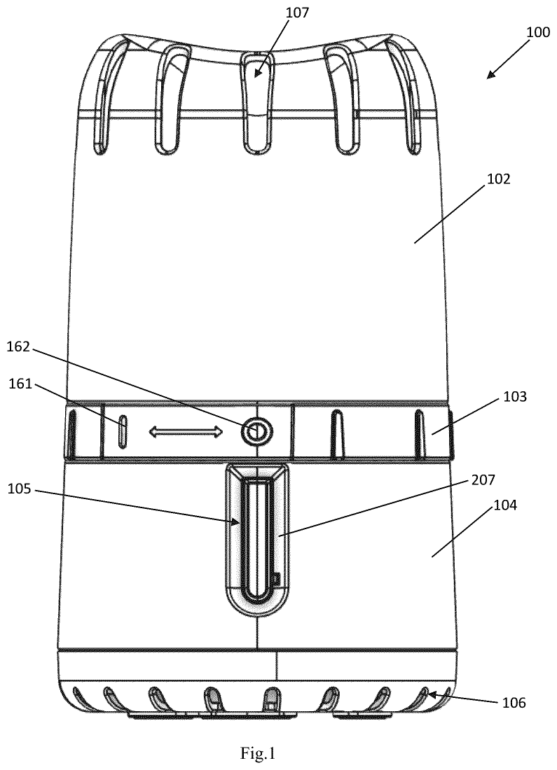

FIG. 1 illustrates an exemplary insect repellent device 100 according to an embodiment of the present disclosure. The device 100 comprises an exterior housing including an upper section 102, an intermediate section or collar 103, and a lower section 104. A repellent receptacle or repellent holder opening 105 is formed into the lower section 104, and is adapted to receive repellent therein (e.g., in the form of an infused pad). Closable lower shutters or vents 106 are adapted to selectively permit air to enter the device 100. During operation, air drawn into the device 100 (e.g., via an internal fan) is exposed to repellent contained therein, and exits via a plurality of upper openings 107. The device 100 may be powered on (i.e., its internal fan activated) via the rotation of the collar 103 from the “OFF” position 162 to the “ON” position 161. In addition to functioning as an electrical switch, rotation of the collar 103 is also operative to selectively open and close both the lower shutters 106, as well as a plurality of internal shutters (not visible) arranged above the repellent opening 105. In this way, with the device 100 in the “OFF” position 162, airflow is cut off both above and below the repellent arranged within the repellent opening 105, extending its service life.

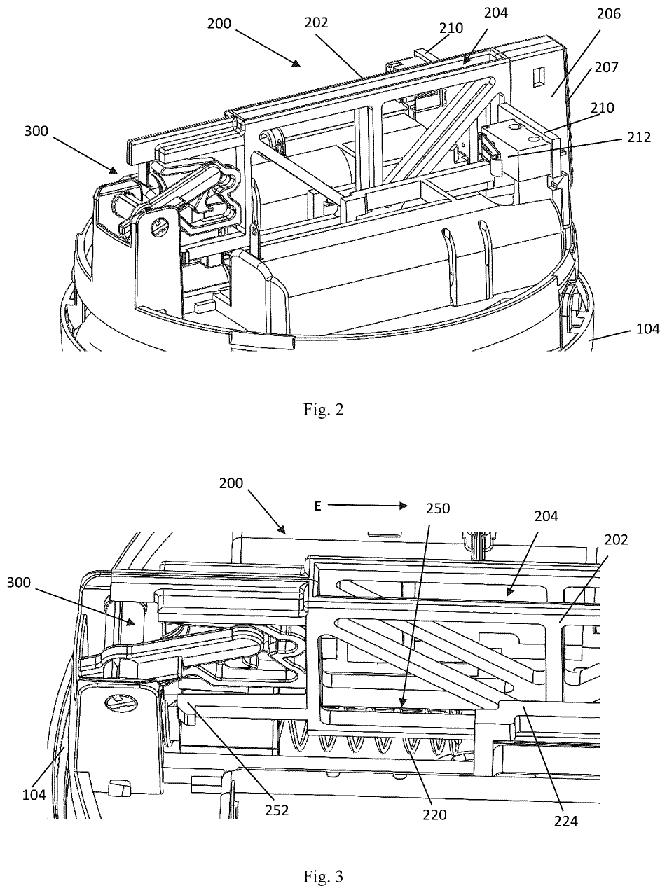

Embodiments of the present disclosure may include a repellent holder (e.g., a repellent pad holder) which may be at least partially uninstalled from the device 100 in order to facilitate repellent pad replacement. FIG. 2 illustrates an exemplary repellent holder assembly 200. The holder assembly 200 primary includes a repellent holder 202 suitable for retaining, for example, a replaceable repellent pad. The holder 202 take the form of a generally hollow frame-like structure, including a first slot 204 adapted to receive a repellent pad. A free end 206 of the holder 202 may be generally solid, allowing grasping or manipulation by a user without the need to contact a repellent pad contained therein. In some embodiments, the end 206 is at least partially translucent, or includes a light pipe 207 for conducting light generated from within the device 100.

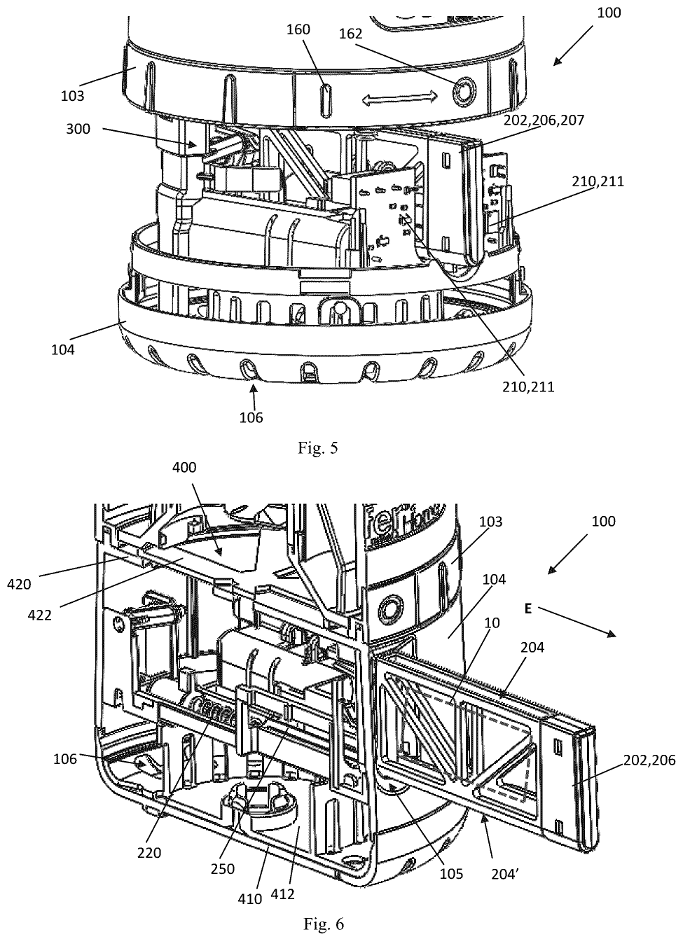

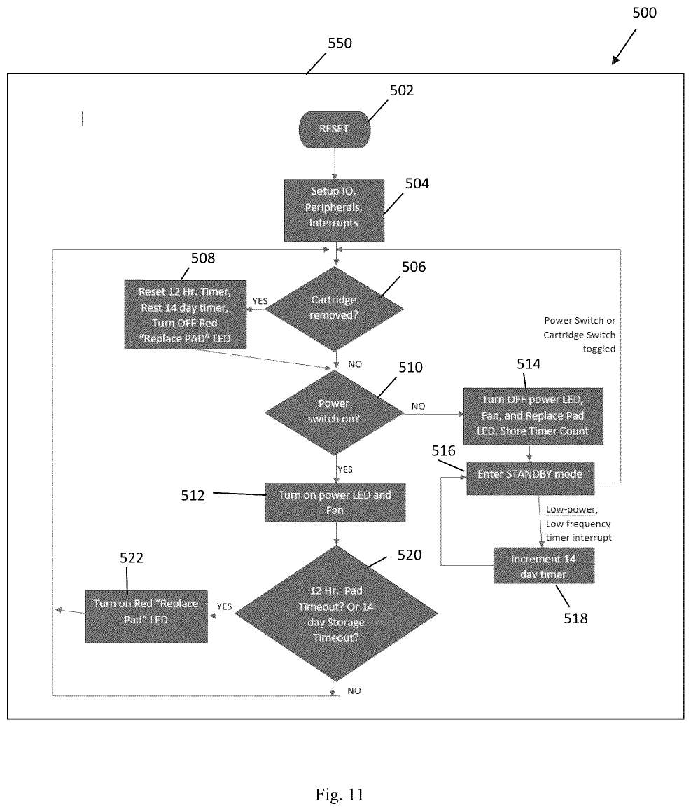

The repellent holder assembly 200 further includes a printed circuit board (PCB) 210 on which, for example, one or more switches, sensors, and/or detectors 212 may be mounted. In the exemplary embodiment, the PCB 210 is generally U-shaped, defining a central slot or opening through which the holder 202 passes. The PCB 210 is also representative of at least one controller or processing unit (CPU, GPU, ASIC, etc., see also FIG. 11) operatively connected to the detector(s) 212, as well as representative of at least one light source such as a light-emitting diode (LED). Such features are generally illustrated or represented on the side of the PCB 210 shown in FIG. 5, for example. The PCB 210 and detector(s) 212 are adapted to determine the position of the holder 202 within the device 100, or in one embodiment, at least its presence or absence in the installed position. The detector(s) or switches 212 are also adapted to, for example, detect, or be activated by, rotation of the collar 103, and thus control the ON/OFF functionality of the device 100. While not described in detail herein, the necessary placement and number of these components in order to achieve the functions described in detail herein would be understood to one of ordinary skill in the art.

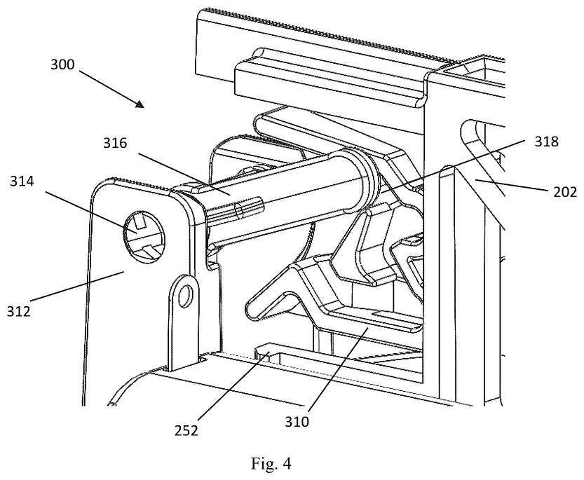

In FIG. 2, the holder 202 shown in a first or installed position, as it would be during normal operation of the device 100, although a repellent pad has been removed for clarity. The holder 202, or a mechanical slide associated therewith, is held in this first position via a latch or lock mechanism 300, as will be set forth in greater detail with respect to FIG. 4. The lock mechanism 300 may be embodied as a “push-push” type mechanism, wherein the holder 202 is locked in the installed position by biasing it toward the lock mechanism 300. Likewise, to release the holder 202 and allow it to slide, a similar repeated pushing force is placed on the holder 202 in the same direction (i.e., toward the lock mechanism). This type of latch or lock is known, and will therefore only be generally described herein.

With reference to FIG. 3, an elastic element such as a coil spring 220 is arranged generally between a portion of the housing 104 and the holder 202, or between the housing and a mechanical slide 250 to which the holder 202 is attached. In some embodiments, the holder 202 and slide 250 may form a single component. The holder 202 may be slidably guided within the device 100 by an internal track 224. The spring 220 is adapted to bias or slide the holder 202 out of the first or installed position, and toward a second or loading position in the indicated ejection direction E, whereafter the holder may be loaded/reloaded. See also FIG. 6. The holder 202 and/or the mechanical slide 250 may include a mechanical stop 252 in the form of a latch used to limit the travel of the holder in the direction E. In this way, in one embodiment, the holder 202 may be prevented from being completely removed from the device 100. This prevents the accidental loss or misplacement of the holder 202 during repellent servicing, resolving a common problem of prior art devices.

As shown in FIG. 4, the lock or latch mechanism 300 is adapted to selective fix the holder 202, or slide 250 associated therewith, in the installed position against the elastic force applied by the spring 220. A rear of the holder 202 or slide 250 includes a guide catch or guide track 310. The housing 104 generally defines a bracket including a clevis 312 through which a pivoting member 314 is rotatably mounted. A latch arm 316 is fixedly attached to the member 314 such that it too is rotatable. A guide pin 318 is formed on an end of the latch arm 316 and is adapted to engage with the guide track 310. In operation, when the holder 202 is pressed into the device 100 a sufficient distance toward the lock mechanism 300, the pivoting guide pin 318 engages with the guide track 310. Once bottomed out within the device 100, the holder 202 can be released and the guide pin 318 locks in place within the guide track 310 to prevent the holder from motion in the direction E. To release or eject the holder 202, the holder is pressed inwardly again until it bottoms out. Upon its release, the guide pin 318 is released from the guide track 310 and the holder 202 is free to slide in the ejection direction E under the force of the spring 220.

Referring now to FIG. 5, the device 100 is shown with a lower portion of the housing removed. In the figure, the PCB 210 is illustrated with components 211 mounted thereon. As set forth above, these components 211 may be LEDs, processing devices, memory devices for storing program instructions accessible by the processing devices, or any other electronic components necessary to perform the device operations described herein. The lower portion of the housing 104 is also shown with the lower shutters or vents 106 thereof in a closed position. This is indicated by the alignment of the holder 202 with the “OFF” indicating symbol “O” 162 arranged on the collar 103 of the housing. As will be set forth in greater detail herein, rotation of the collar 103 to align the holder 202 with the “ON” indicating symbol “I” 160 is operative to open the lower vents 106 and permits airflow into the device 100.

FIG. 6 illustrates the device 100 with the holder 202 in a loading or second position after its release from the lock assembly 300 and sliding biasing by the spring 220. In the second position, the holder 202 has at least partially exited the lower device housing 104 via a repellent opening or repellent holder opening 105. A repellent pad 10 is illustrated in an installed position within the holder 202. In one embodiment, in addition to the top opening or slot 204, the holder 202 has a bottom opening or slot 204′. In this way, a user may install a new pad 10 into the holder 202 via the top opening 204, displacing the old pad through the opening 204′. This avoids a user having to touch or otherwise contact the waste pad during its replacement.

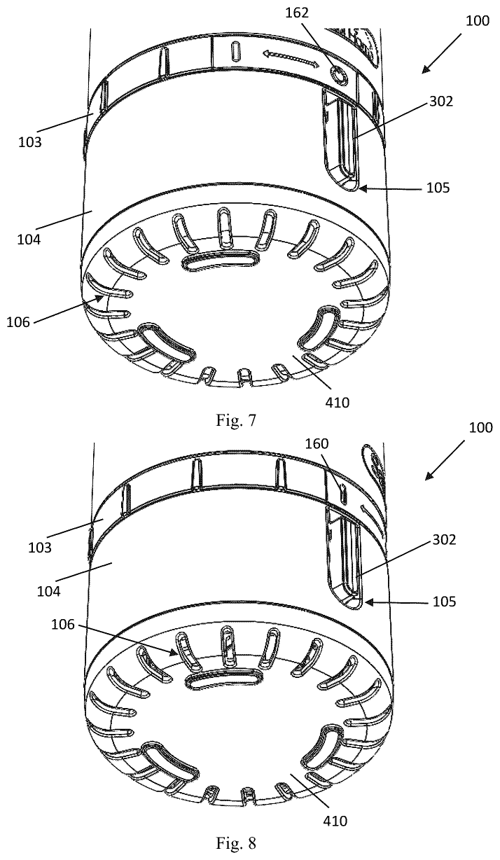

The lower shutters or vents 106 are defined by apertures defined in a housing element 410 that forms part of the lower housing 104, and apertures formed in a rotatable inner element 412. Likewise, the lower housing 104 defines a second set of apertures or openings arranged above the holder 202. These apertures may be formed through an upper element 420 operatively connected to the housing element 410. A second rotatable inner element 422 coupled to element 412 comprises corresponding apertures. Thus, the openings or apertures in the rotating elements 420,422 align to form upper vents or shutters 400. The elements 412,422 are connected such that they rotate in unison via the collar 103. In this way, the upper and lower vent openings 400,106 are opened and closed in unison as the device is moved between the “ON” and “OFF” state via the collar 103. This can be seen more clearly in FIGS. 7-10.

FIG. 7 illustrates the device 100 in the deactivated state, wherein the lower shutters or vents 106 are closed, preventing air from entering the device. This deactivated state is also indicated in FIG. 10, wherein misalignment of the openings of the elements 420,422 result in the closing of the upper vents or shutters 400. The repellent holder assembly 200 has been removed from the figure for visual clarity.

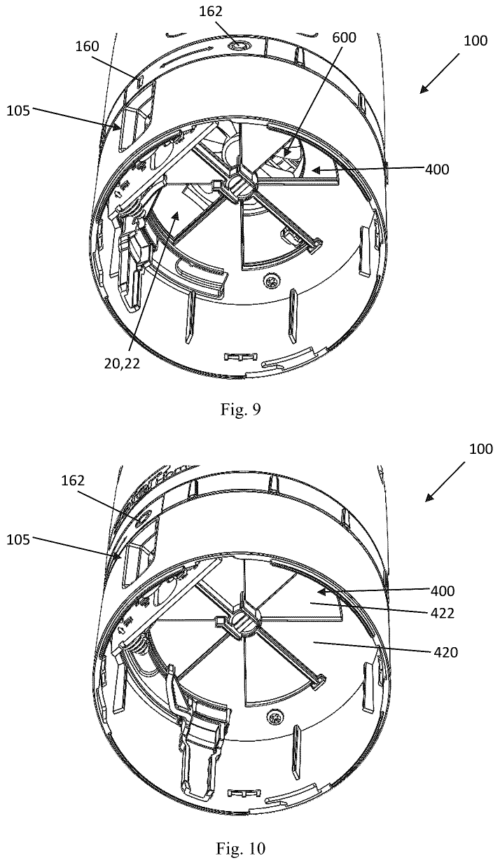

In contrast, and referring to FIGS. 8 and 9, via the rotation of the collar 103, the openings in the above-described coaxial elements 410,420 and 412,422 align, opening the lower vents 106 as well as the upper vents 400. This is indicated by the alignment of the holder 202 and/or repellent opening 105 with the “ON” indicator 160. With the upper and lower vents 400,106 in the open position, operation of an internal fan 600 (see FIG. 9) draws air through the lower vents 106, past the repellent pad 10, and through the upper vents 400, wherein it is vented into the atmosphere via the upper housing openings 107 for repelling insects. In FIG. 9, it should be understood that the repellent holder assembly 200 has also been removed for visual clarity.

FIG. 11 is a simplified diagram illustrating the exemplary operation 500 of a device (e.g., the device 100) according to an embodiment of the present disclosure via at least one programmable processor or controller 550. With the device reset 502 (e.g., via initial setup, user reset, etc.), an internal setup or initiation function 504 will take place and ready the device for use. Once ready, one of more controllers of the device will operate in conjunction with one or more sensors to determine or detect 506 the presence or absence of a repellent holder or cartridge in an installed position within the device. If the repellent holder is not detected, indicating it has been removed or never installed, a reset operation 508 is performed. During the reset operation 508, a first timer or clock (e.g., a count-down timer) associated with the device in an “ON” or activated state will be reset (e.g., to 12 hours). Likewise, a second timer or clock associated with the device in an “OFF” or deactivated state of the device will be reset (e.g., to 14 days). Any user indicators (e.g., LEDs indicating the need to replace the repellent) will also be turned off. The default values of these timers may be varied, of course, depending on the expected useful lifespan of the repellent, by way of example. It should be understood that these first and second timers may be digitally implemented by the processor or controller 550, or other like components.

If the repellent holder is determined to be installed during detection 506, the device will then determine 510 if its power switch is “ON” (e.g., the position of the collar 103 in the device 100). If the device's power switch is “OFF”, deactivation 514 will be performed, wherein the device will turn off its power indicator and any repellent replacement indicators, as well as store any timer count(s) (e.g., at least the first timer count). After completion, the device will enter a standby mode 516 in which only the second or day timer will be incremented 518. If during determination 510 the power switch is found to be “ON”, the device will activate 512 a “power-on” visual indicator and activate its internal fan, thus beginning normal device operation. In this activated state, the device will interrogate or read 520 its first and/or second timers. If at least one of the timers has timed out, a user will be indicated 522 (e.g., via an LED). If no timeout has occurred, however, the above-described monitoring cycle will continue as described. It should be understood that under normal device operation, the first timer will only increment when the device is in the “ON” position or state, while the second timer will only increment when the device is in the “OFF” position or state.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present disclosure are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. An insect repellent device, comprising:
a selectively closable vent providing fluid communication between an interior of the device and an external environment;
a repellent holder movable between an operating position, and a loading position wherein the repellent holder is arranged at least partially outside of the device; and
a sensor adapted to detect the presence of the repellent holder in the operating position.

2. The insect repellent device of claim 1, further comprising a controller responsive to an output of the sensor and adapted to determine a duration of time the repellent holder is maintained in the operating position.

3. The insect repellent device of claim 2, wherein the controller is further adapted to:
determine a duration of time the repellent holder is maintained in the operating position and the device is in an activated state; and
determine a duration of time the repellent holder is maintained in the operating position and the device is in a deactivated state.

4. The insect repellent device of claim 2, further comprising at least one indicator responsive to the controller and adapted to alert a user when the determined duration of time reaches a predetermined duration of time.

5. The insect repellent device of claim 1, wherein the repellent holder includes an entry opening adapted to receive a repellent pad with the repellent holder in the loading position.

6. The insect repellent device of claim 5, wherein the repellent holder further includes an exit opening adapted to permit the removal or ejection of a repellent pad arranged within the repellent holder with the repellent holder in the loading position.

7. The insect repellent device of claim 1, wherein the repellent holder is slidably mounted within a repellent opening formed at least partially through the device.

8. The insect repellent device of claim 7, wherein the repellent holder is elastically biased from the operating position toward the loading position.

9. The insect repellent device of claim 8, further comprising a locking mechanism for selectively fixing the repellent holder in the operating position.

10. The insect repellent device of claim 9, wherein:
the repellent holder is locked in the operating position by biasing the repellent holder in a first direction through the repellent opening; and
the repellent holder is unlocked from the operating position by biasing the repellent holder in the first direction.

11. The insect repellent device of claim 1, wherein the selectively closable vent includes:
a first vent arranged on a first side of the repellent holder; and
a second vent arranged on a second side of the repellent holder, opposite the first side, the first and second vents adapted to be opened and closed simultaneously.

12. The insect repellent device of claim 11, wherein the first and second vents are selectively opened and closed via rotation of a collar arranged on an exterior of the device.

13. The insect repellent device of claim 1, wherein the device is adapted such that:
opening of the vent automatically activates an internal fan of the device; and
closing of the vent automatically deactivates the internal fan.

14. An insect repellent device, comprising:
a housing including an at least partially removable repellent holder;
a controller; and
at least one sensor operatively connected to the controller and adapted to detect the presence or position of the repellent holder within the housing.

15. The insect repellent device of claim 14, wherein, in response to a detection of the repellent holder arranged in an operating position within the housing, the controller is adapted to:
initiate a first timer when the device is in an activated state; and
initiate a second timer when the device is in a deactivated state.

16. The insect repellent device of claim 15, wherein, in response to at least one of the first timer or the second timer reaching a respective first or second predetermined value, the controller is adapted to activate an indicator of the device alerting a user to a status of repellent held by the repellent holder.

17. The insect repellent device of claim 16, wherein:
the first predetermined value is indicative of an expected life of the repellent with the device in the activated state; and
the second predetermined value is indicative of an expected shelf-life of the repellent with the device in the deactivated state.

18. The insect repellent device of claim 16, wherein the controller is further adapted to reset the first timer and the second timer in response to a detection that the repellent holder has been removed from the operating position.

19. A method of operating an insect repellent device comprising the steps of:
with a repellent holder in an operating position within the device and the device in an activated state, activating a first timer;
with the repellent holder in the operating position within the device and the device in a deactivated state, activating a second timer;
if the first timer reaches a first predetermined threshold time, providing an alert to a user; and
if the second timer reaches a second predetermined threshold time, providing an alert to the user.

20. The method of claim 19, further comprising the step of, in response to a detected removal of the repellent holder from the operating position:
resetting the first and second timers; and
repeating the steps of claim 19.
